(19) United States
(12) Patent Application Publication
(10) Pub. No.: US 2005/0131778 A1
(43) Pub. Date: Jun. 16, 2005

(54) Customized subscription builder

(75) Inventors: Valerie M. Bennett, Macon, NC (US); George L. Fridrich, Cary, NC (US); Mohit Jain, Durham, NC (US)

Correspondence Address: MARCIA L. DOUBET, P. O. BOX 422859, KISSIMMEE, FL, 34742, US

(73) Assignee: International Business Machines Corporation, Armonk, NY (US)

(21) Appl. No.: 10/733,985

(22) Filed: Dec. 11, 2003

(51) Int. Cl. G06F 17/60

(52) U.S. Cl. 705/29

(57) ABSTRACT

Techniques are disclosed for enabling end users to selectively subscribe to information content, without requiring the content provider to provide a subscription interface. A user preferably views a content source (such as a Web page) in a Web clipper, and selects content of interest. In preferred embodiments, the user's selection are then communicated to a component which transcodes them into a markup language document, and this document is used to create a set of one or more conditions to use when evaluating whether a subsequent version of the original content is of interest to this subscribing user. The conditions are preferably registered with a content matching component, and one or more actions to be taken upon a successful match are also stored for use at the time of the subsequent content evaluation.

### RELATED INVENTIONS

The present invention is related to the following commonly-assigned inventions, which were filed concurrently herewith: U.S. Pat. No. ______ (Ser. No. ______), titled “Intelligent Subscription Builder” and U.S. Pat. No. ______ (Ser. No. ______), titled “Intelligent Data Query Builder”. These co-pending applications are hereby incorporated herein by reference.

### BACKGROUND OF THE INVENTION

1. Field of the Invention

The present invention relates to computer software, and deals more particularly with techniques for enabling end users to selectively subscribe to information content, without requiring the content provider to provide a subscription interface.

2. Description of the Related Art

In today's networked world, a user can be notified of events in a number of ways, including via their instant messaging client, e-mail client, or personal digital assistant (“PDA”). Unfortunately, however, users are limited to what they can be notified about because they are restricted to predetermined data feeds which are defined by other parties such as a software vendor or Web portal. Well-known examples of such data feeds include delivery of current weather, stock prices, and news to subscribers. Currently, the provider of the content is required to deploy a subscription interface that enables users to subscribe to content. Using the subscription interface, users indicate that they would like a particular data feed delivered to a client application over a communications network.

There are several drawbacks to existing techniques. If a content provider has not provided a subscription interface, then users are unable to subscribe to the content. Instead, they have to repeatedly take explicit action to continue viewing the content, such as returning to the content provider's Web page periodically. Another drawback of existing techniques is that, even if a subscription interface has been provided, it often does not has sufficient granularity to meet the needs or desires of end users. As a result, the user effectively gets no say as to what data feed is important to him/her.

The present invention provides novel techniques for enabling end users to selectively subscribe to data feeds.

### SUMMARY OF THE INVENTION

An object of the present invention is to enable end users to selectively subscribe to data feeds.

Another object of the present invention is to provide techniques with which end users can control conditions under which content is delivered.

A further object of the present invention is to define techniques which allow end users to selectively receive content, without requiring content providers to deploy a subscription interface.

Other objects and advantages of the present invention will be set forth in part in the description and in the drawings which follow and, in part, will be obvious from the description or may be learned by practice of the invention.

To achieve the foregoing objects, and in accordance with the purpose of the invention as broadly described herein, the present invention may be provided as methods, systems, and computer program products. In one aspect of preferred embodiments, the present invention provides techniques for selectively subscribing to content in a computing environment, comprising: enabling a user to identify content of interest, wherein a provider of the content has not provided a subscription interface thereto; and registering a subscription, for the user, to the identified content. The registered subscription is preferably used to deliver updates of the identified content to the user and/or to carry out other action(s). The identification of content may be customized, such that at least one condition is placed on at least one portion of the identified content (where the portion may comprise the entire identified content), wherein the content provider may have provided the subscription interface to the identified content but has not provided a subscription interface using all of the conditions and/or all of the portions. In this case, registering the subscription preferably further comprises registering the customization, and the registered subscription may then be used to deliver updates of the identified content which match the condition(s) and/or to carry out other action(s). Subscriptions may be registered for a plurality of users, if desired, and content updates may be evaluated according to those registered subscriptions.

The present invention will now be described with reference to the following drawings, in which like reference numbers denote the same element throughout.

### BRIEF DESCRIPTION OF THE DRAWINGS

FIG. 1 provides a sample Web page illustrating content to which a user may selectively subscribe, using techniques disclosed herein;

FIG. 2 illustrates a sample display showing content to which a particular user wishes to subscribe;

FIG. 3 illustrates a sample XPath file used when discussing operation of preferred embodiments;

FIGS. 4 and 7 illustrate subscription menus of the type that may be provided by preferred embodiments to enable users to customize their subscription;

FIGS. 5 and 11 provide flowcharts illustrating logic that may be used when implementing aspects of a CP2XML component used in preferred embodiments of the present invention;

FIG. 6 provides a markup language document representing sample input to the CP2XML component;

FIG. 8 provides a sample markup language document illustrating a result of customizing a user subscription;

FIGS. 9 and 13 provide flowcharts depicting logic that may be used when implementing aspects of a trigger handler component used in preferred embodiments;

FIG. 10 provides a flowchart depicting logic that may be used when implementing a content adapter component used in preferred embodiments;

FIG. 12 provides a sample markup language document illustrating refreshed content to be evaluated with reference to a subscribing user, according to preferred embodiments;

FIG. 14 depicts an example client application executing on a client device, showing how information may be delivered according to a user-customized subscription; and

FIG. 15 shows components and flows used in preferred embodiments of the present invention.

### DESCRIPTION OF PREFERRED EMBODIMENTS

The present invention provides techniques that enable an end user to go to a Web site (or analogous network-accessible content view), select the content in which he or she is interested, and then dynamically subscribe to this content. The disclosed techniques can be used effectively to subscribe to any data on the Internet (or other network; references herein to “Internet” or “Web” are by way of illustration but not of limitation). Users can therefore receive content of their choice, without regard to whether the content provider has deployed a subscription interface. In addition, in cases where a subscription interface has been deployed, use of the present invention allows users to overcome limitations that may be inherent therein, without dependence upon the content provider to alter and re-deploy an improved interface. Individual information needs of users are therefore addressed through use of the present invention.

Another advantage offered to users by the present invention is that the users do not need to subscribe to fee-based subscription services in order to receive content in which they are interested. An advantage offered to businesses is that their content can now be readily available to users, in a manner selected by each individual user, thereby improving timeliness and value of the content as well as increasing end-user satisfaction.

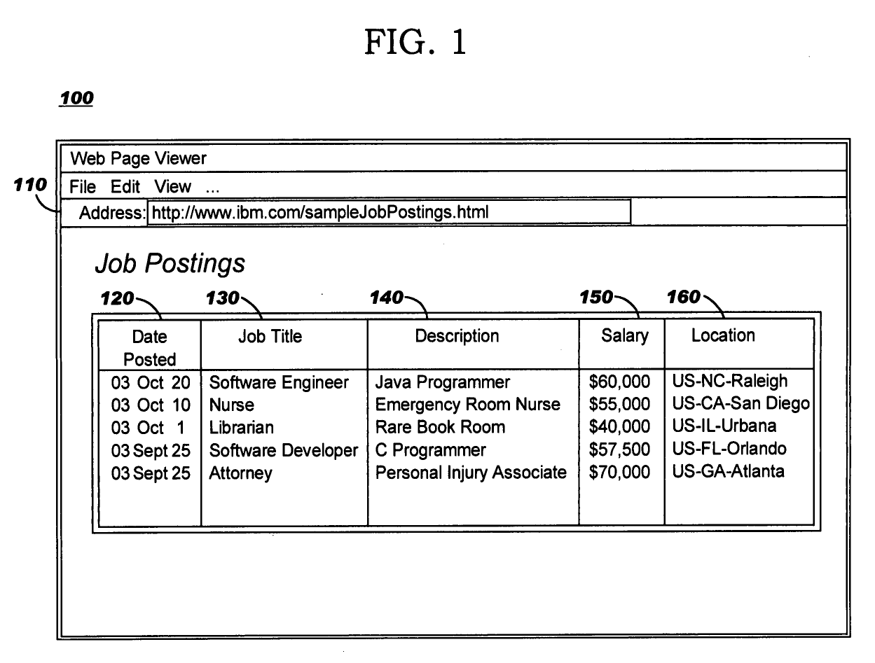

Preferred embodiments will now be described in more detail with reference to FIGS. 1-15.

The sample Web page 100 depicted in FIG. 1 is used herein to illustrate how an end user might select content for which a subscription will be created using techniques of the present invention. As shown therein, the sample Web page 100 corresponds to a Web site on which job openings are posted. In this example, job postings include software engineer, nurse, librarian, software developer, and attorney. See the Job Title column 130. The sample Web page also includes a Date 120 on which the job opening was posted; a Description 140, providing more information about each job opening; the Salary 150 for this job opening; and the Location 160 of this job opening.

Embodiments of the present invention enable a user to subscribe to this Web page content in a user-customized manner. The user can thereby be notified of updates to the content, and can choose to receive only the data that is of interest to this user. For example, suppose a particular user is interested in computer programming-related jobs. This user might be interested in the software engineer and software developer postings shown in FIG. 1, but would likely be uninterested in availability of jobs for nurses, librarians, and attorneys.

According to preferred embodiments, the user employs a clipping paradigm to indicate the data of interest on a displayed Web page. For example, the user might select the Job Title, Salary, and Location columns 130, 150, 160 of the Web page 100 in FIG. 1 with a pointing device such as a mouse or light pen. When using a mouse, selection may be performed by depressing the left mouse button on cells of interest within a tabular display. Or, the user might drag the mouse cursor to highlight the area of interest within a content display. Hereinafter, embodiments of the present invention are described with reference to selecting content from a tabular display. Typically, the selected areas will be highlighted using a visual distinction, such as a different color. After selecting content of interest, the user preferably signals that an action is to be taken relative to this highlighted area One manner in which an action of interest to embodiments of the present invention might be represented is with a choice such as “Create Subscription” on a menu that pops up responsive to depressing the right mouse button. As will be obvious, other alternative techniques for enabling a user to select content of interest and to signal an action may be used without deviating from the scope of the present invention. As one example, a function key or keystroke sequence might be used (instead of depressing the right mouse button) to signal that the user wishes to create a subscription after selecting content. Or, the user might first signal an intent to select content, and then proceed to make one or more selections (by clicking in cells of a table, for example).

Referring briefly to FIG. 15, which shows components and flows used in preferred embodiments of the present invention, a Web clipper component or “clipping engine” 1520 is preferably leveraged for use in the selection/clipping operation. The sample Web page 100 is shown at 1501 as input to this Web clipper 1520. Web clippers are known in the art. As one example, WebSphere Portal Server Version 4.1, a commercially-available product of International Business Machines Corporation (“IBM”) provides a Web clipper, referred to herein as the “WSPS Web clipper”. The manner in which this WSPS Web clipper (or another Web clipper) may be used with embodiments of the present invention will now be described in more detail.

Using the WSPS Web clipper, a user provides the Uniform Resource Locator (“URL”) of the Web page of interest. For example, if the Web page 100 in FIG. 1 appears at URL “www.ibm.com/sampleJobPostings.html”, as shown at reference number 110 in FIG. 1, then this URL would be specified to the WSPS Web clipper. The WSPS Web clipper then renders a copy of the content from the provided URL, and allows the user to selectively clip content from the rendered copy. (The rendering of the Web page within the Web clipper has not been depicted.) Using an “HTML clipping” method (which is the default WSPS Web clipper method), the output of the Web clipping operation is a Hypertext Markup Language (“HTML”) document.

Using the WSPS Web clipper, the user clicks on each rendered field or element of interest from a Web page, and that element is then highlighted by the WSPS Web clipper to show that it has been clipped.

A “Preview” option is provided in the WSPS Web clipper, with which the user can verify the elements that have been selected. In preferred embodiments, the prior art Web clipper is leveraged without requiring changes thereto. Alternatively, a prior art Web clipper may be augmented to incorporate a “Subscribe” option therein. Hereinafter, discussions of preferred embodiments are in terms of using a prior art Web clipper that has not been modified.

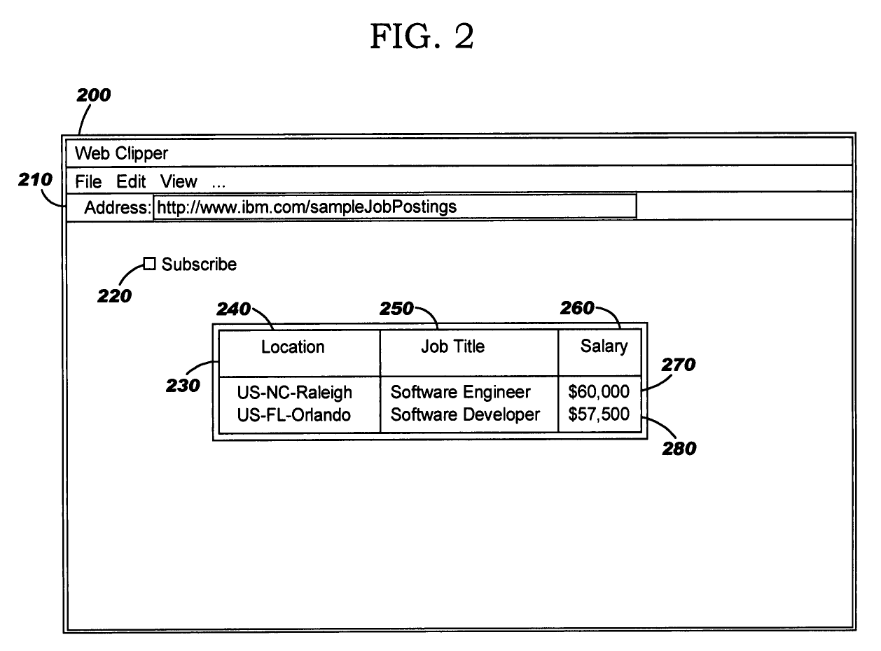

Turning now to FIG. 2, a sample Web clipper display 200 is depicted. In the sample display, the URL from which the content was clipped is provided at 210. A check box 220 is also provided on this interface to the WSPS Web clipper, which the user can check to signify that he/she wishes to subscribe to the content as displayed in preview area 230. This preview area 230 corresponds to the user's selections from Web page 100. Note that, in this example, the order of the previewed columns 240, 250, 260 differs from the order of the columns presented in the original Web page 100. This indicates that the user may optionally be allowed to change the column ordering for the subscription being created. For example, the user in this case may have selected column 160 (“Location”) first, followed by column 130 (“Job Title”), and then column 150 (“Salary”). When content is presented in the Web clipper in a tabular format, users may indicate their content selection by selecting column headers from displayed Web page, by selecting rows, and/or by selecting individual cells. Other approaches to selection may also be used. (Furthermore, it is not strictly necessary that a Web clipper component be provided. Alternatives include writing code that extracts the user's selections from a displayed Web page, and manually creating a representation of content selection that adheres to formats used by an implementation of the present invention.)

In the example of FIG. 2, two rows 270, 280 are presented, indicating that the user selected a subset of the rows in the job postings Web page 100. Alternatively, if the user had not selected individual rows, the preview area 230 preferably contains a row corresponding to each displayed row of Web page 100. (Or, if desired for a particular implementation, preview area 230 might contain only column headings in this situation.)

When using the WSPS Web clipper, XPath syntax is generated when the user selects items on the displayed Web page. Preferred embodiments parse the underlying content of the Web page (which is typically specified in HTML syntax) and the available XPath is applied to reflect the user's selection. XPath notation is well known in the art, and a detailed description thereof is therefore not presented herein. For more information, reference may be made to the XPath specification, which is titled “XML Path Language (XPath)” and which is available from the World Wide Web Consortium.

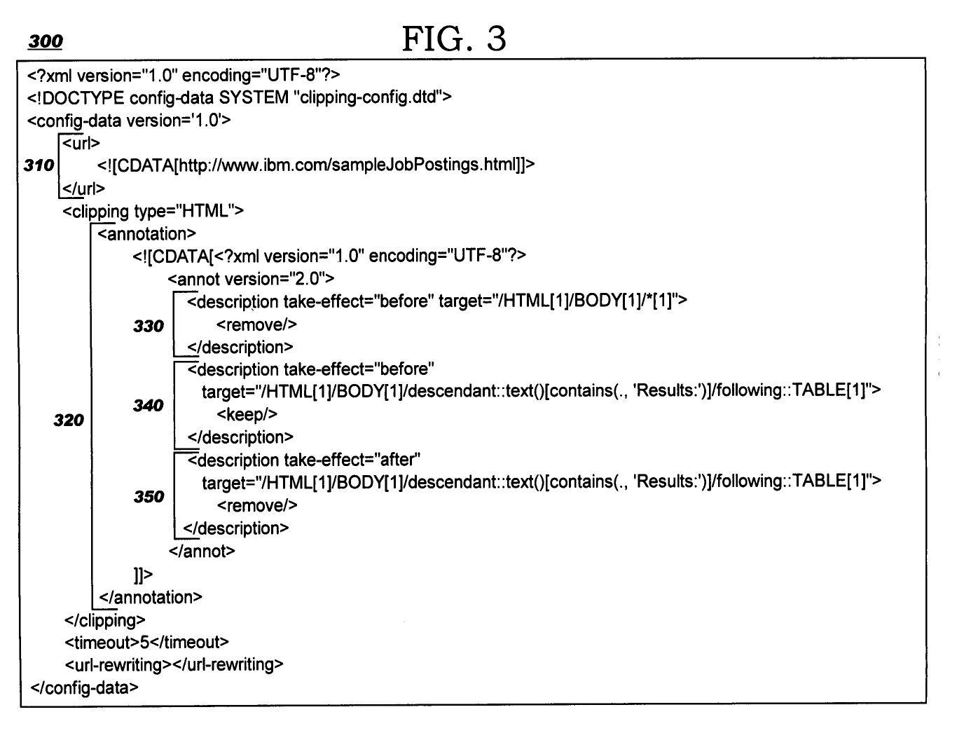

The WSPS Web clipper accepts, as input, a name to associate with the XPath file to be created for this user's content selection. For example, the user clipping content from the job postings Web page 100 might provide a name of “JobPostingsClipper”. Or, this name might be generated programmatically, without requiring user input. FIG. 3 shows sample XPath statements 300 corresponding to the user's selections from Web page 100. The “url” element 310 specifies the source file to which the annotation defined at 320 is to be applied for clipping content. The “description” elements 330, 340, 350 specify, in this example, that everything in the HTML page prior to the first child of the first BODY tag should be removed (element 330); that the descendent text which includes the string “Results:” within the first TABLE tag should be kept (element 340); and the elements following the closing of that kept element should be removed (element 350).

The user may iteratively make selections while viewing the preview 230 in the Web clipping engine 200, if desired. Once the previewed selections are acceptable, the user activates the Subscribe check box 220 (or otherwise indicates that he/she wishes to subscribe to the previewed content). The selections which the user has chosen are then preferably serialized as a table specified in HTML notation.

In an optional enhancement of preferred embodiments, the user may be allowed to subscribe to a subset of the fields displayed in the Web clipper. For example, if the user has selected the Location, Job Title, and Salary fields from Web page 100, those three fields will be displayed on the Web clipper display (i.e., subscription page) 200. By not entering any value in the text entry field associated with Location, for example, the user thereby indicates his/her desire to subscribe only to content in the Job Title and Salary fields when this optional enhancement is implemented. (If the user fails to enter values in any of the text entry fields, this is preferably treated as an error condition requiring correction by the user.)

Referring again to FIG. 15, reference number 1502 indicates that the user's subscription information is forwarded to a component referred to herein as “CP2XML” 1530. The CP2XML component receives the forwarded serialized information, along with an indication of the source (e.g., the URL) from which the content was originally clipped. The CP2XML component then transcodes the serialized information. Preferably, the output of the transcoding operation is an Extensible Markup Language (“XML”) document. (Note that if a clipping component is not used in a particular implementation of the present invention, the HTML content to be transcoded may be created using other means, including a simple text editor, and forwarded to the CP2XML component for transcoding. As another alternative, the XPath statements illustrated by the example in FIG. 3 may be written using other means, including a text editor or other tool, and the XPath statements can then be executed against the source file to generate the HTML content to be delivered to the CP2XML component.)

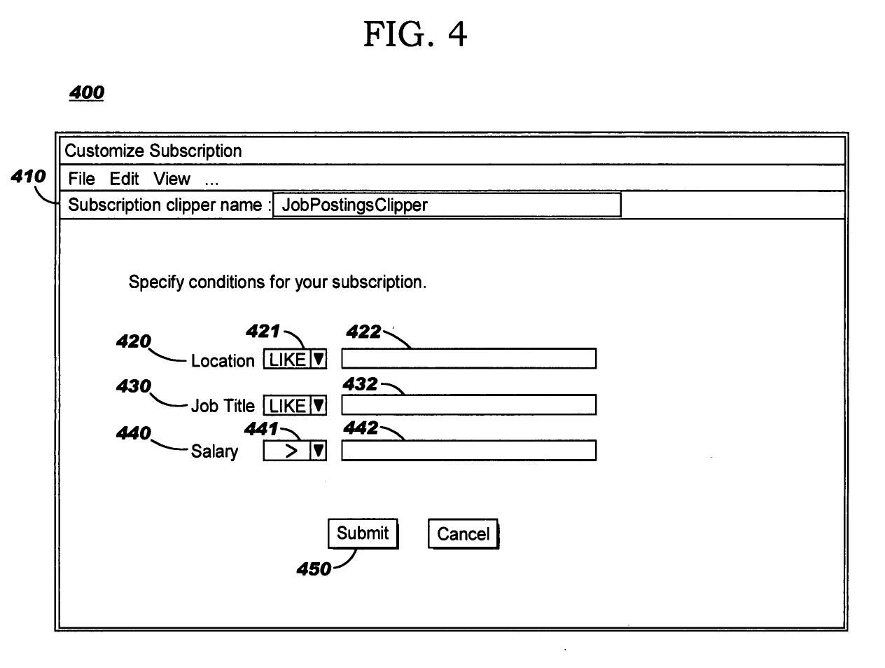

Operation of the CP2XML component will now be described in more detail with reference to FIGS. 4-8 and 15. FIG. 4 provides a sample subscription page 400 with which the user can customize his/her subscription by specifying conditions that must occur before the user is interested in receiving a content update. In preferred embodiments, this page is built from the HTML input provided by the Web clipping component. Reference number 1503 of FIG. 15 represents the CP2XML component 1530 creating and rendering this subscription page 400 to the user.

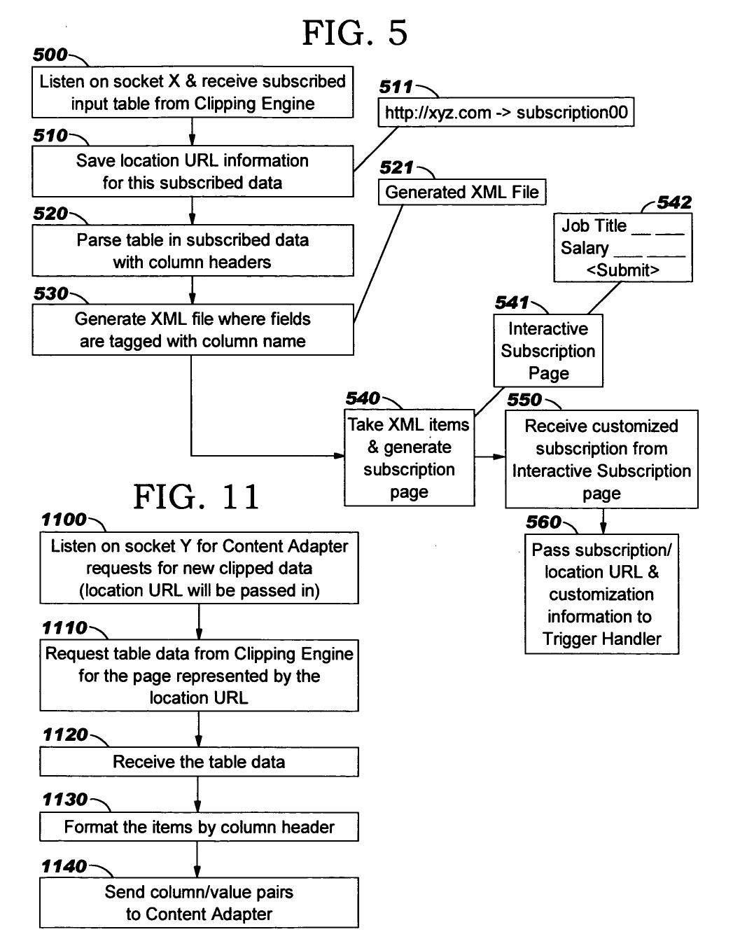

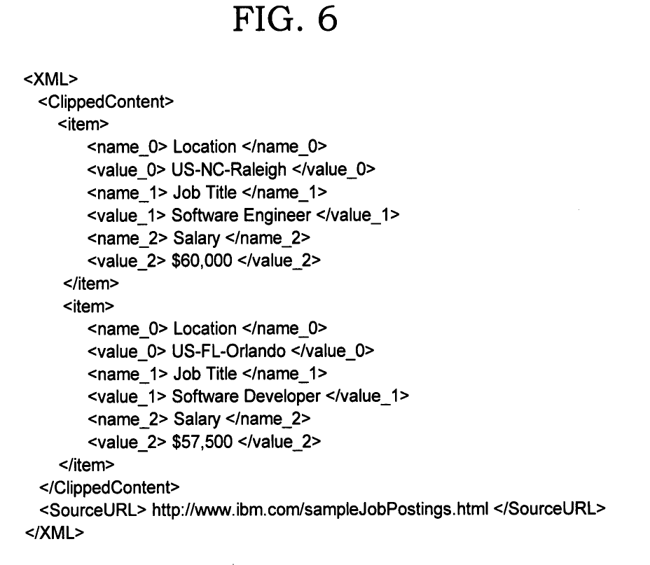

As indicated by the flowchart in FIG. 5, one aspect of the CP2XML component of preferred embodiments listens on a socket (referred to in FIG. 5 as “socket X”, for illustrative purposes), where it receives the HTML input in tabular format from the Web clipping component (Block 500). The location URL associated with this subscribed data, which is also provided from the Web clipping component as discussed earlier, is saved by the CP2XML component (Block 510). For example, as indicated at reference number 511, a location URL of “http://xyzcom” may be associated with subscription information identified as “subscription00”. The CP2XML component then parses the provided HTML table, extracting its column headings (Block 520), and generates an XML file (Block 530) containing that information. Preferably, the XML file uses the column names as tag values. This generated XML file is represented in FIG. 5 at reference number 521. See also the example XML file in FIG. 6, which may be created by the CP2XML component to correspond to the user's selections as shown in FIG. 2. The XML file created at Block 530 is then used to generate (Block 540) the subscription page, an example of which is depicted in FIG. 4.

Reference numbers 541 and 542 in FIG. 5 indicate that the user interacts with this subscription page to customize his/her subscription, and selects to submit that customization when ready (as has been discussed above with reference to FIG. 2). The CP2XML component then receives the customization input (Block 540), and passes (Block 550) the URL of the source Web page and the customization information to a trigger handler component.

Turning again to FIG. 4, the customization operation provided in preferred embodiments will now be described in more detail. The name to be associated with this customization, which has been preferably been selected by the user or programmatically generated, as discussed earlier, is shown at reference number 410. The column headings selected by the user when viewing Web page 100 in the Web clipper 200 are used to populate the customization display 400. Accordingly, this sample job postings customization display includes Location 420, Job Title 430, and Salary 440 input areas. The user may wish to limit his/her subscription to job openings which are located in particular geographic locations, for example. In this case, the user preferably types one or more locations into text entry field 422. An appropriate delimiter, such as a comma or semicolon, is preferably used when multiple locations are supplied. Wild cards may be supported, if desired. In addition, preferred embodiments preferably use a drop-down list 421 that enables the user to easily specify a wider range of values. For example, the user might select the “LIKE” choice depicted in list 421 and then type “Raleigh, N.C.” into text entry field 422 to indicate that he/she wishes to see jobs in locations similar to Raleigh, N.C. “Similar”, in this context, may be interpreted as geographically nearby. Or, an implementation of the present invention may be adapted for determining factors such as population density, and using cities of similar characteristics for those locations which are “like” Raleigh, N.C. An another example, an implementation may perform a string pattern-matching operation to determine whether one value is “like” another.

A database or other repository of terms, indexed by keywords such as “location”, may be used with an implementation of the present invention to enable making a programmatic determination of which values are similar to those typed in by the user. For example, the database might use “location” as a keyword to retrieve a set of comparison criteria that define how to determine whether one location is similar to another. As another example, “job title” might be used as a keyword that will retrieve a set of criteria indicating how to tell if one job title is similar to another. In this latter case, sets of job titles that are to be considered as matching, such as “Software Engineer” and “Software Developer”, might be specified.

Preferred embodiments leverage a commercially-available component for performing the subsequent comparisons between patterns created by the user on display 400 and the content displayed in the actual Web page to which the user is subscribing. The component responsible for these comparisons is referred to herein as a “content matching engine”, and is discussed in more detail below.

Drop-down list 421 may contain other entries such as “EQUAL”, indicating that the user wants an exact match on values of the job location, or “IN”, indicating that the user has specified some string (such as a state code) that must be found in the location before a job posting is of interest to this user. Preferably, when the value being customized is numeric rather than textual, other choices are provided. An example is shown at 441, illustrating that the user may specify that the salary in the posted job opening must be greater than the value he/she enters in entry field 442 before this user is interested in being notified of the job opening.

Optionally, if the user selected particular displayed values from the source Web page, an implementation of the present invention may automatically provide those values, for example by using a drop-down list containing the values for the appropriate column heading. So, for example, if the user had clicked on the job posting for “Nurse” when using Web clipper 200, the entry field 432 would automatically show “Nurse” as a choice when this option is implemented.

The approach shown in FIG. 4 enables the user to define what type of information he/she wishes to see. Once the subscription information has been defined and processed, the source Web page will subsequently be queried (as discussed in more detail below) to determine whether any content matching the user's filter is currently rendered in that Web page. (The term “filter”, as used herein, refers to customization parameters or conditions which are selected using a customization display such as that shown in FIG. 4.) Thus, in the job postings example, the user might choose to be notified every time a new job opening with a salary over $50,000 is posted. Or, the user might choose to be notified when job openings arise in a selected city or cities or within particular states or regions, and so forth. Once the user has provided values to be used in customizing this subscription, he/she preferably presses a “Submit” button 450 or otherwise indicates that the customization is ready for submission.

As will be obvious, a user may subscribe to many different kinds of content, and the conditions to be specified may vary widely. A user might locate a company's stock price somewhere on the company's home page, for example, and might then choose to subscribe to updates on this stock price. Or, the user might choose to receive updates only when the stock price exceeds some configured amount or percentage of increase (where the amount or percentage is preferably specified by the user during customization).

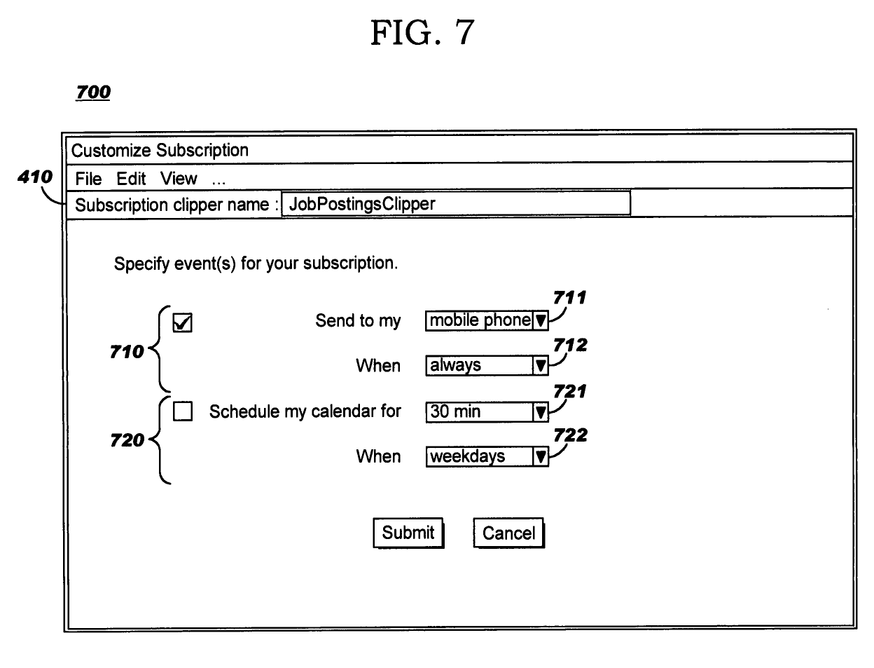

The user may also be allowed to specify one or more events (referred to equivalently herein as “actions”) that should be invoked when the source Web page contains content matching the user's subscription filter, and the choices to be presented to the user may be determined in a number of ways without deviating from the scope of the present invention. A sample display 700 that may used for this purpose is provided in FIG. 7, as will now be described. (Note that the choices depicted in FIG. 7 are merely representative, and an implementation of the present invention may provide additional or different choices.)

As one example of an applicable event, the user may specify that content is to be delivered to a particular device (which may be identified, for example, using a network address or device address). Or, the user might specify that some particular process is to be executed when the filter locates matching content.

In the example of FIG. 7, the user is provided with a first selection 710 with which he/she can indicate that the matching content should be sent to a device. In one approach, a drop-down list 711 may be configured to provide a set of standard, predetermined selections for the target device. In another approach, the choices may be retrieved from an external source such as a configuration file or directory entry. As yet another approach, a database or other repository which uses keywords as an index may be queried to determine which action choices are applicable, given the terms (such as “location”, “job title”, and “salary”) being used in a particular customization. As still another approach, the CP2XML component may be adapted for consulting a user profile or similar source to provide choices which are specifically adapted to the user who is specifying this customization, and then presenting these choices in drop-down list 711. As will be obvious, in this latter approach, a user identifier is preferably obtained by the Web clipping component and communicated to the CP2XML component. Or, the CP2XML component may provide an input means for obtaining the user identifier directly from the user, such as by adding another field to display 400. The user may optionally be authenticated, using authentication techniques which are outside the scope of the present invention.

An optional “when” parameter is also shown in FIG. 7, and preferably uses a drop-down list as shown at 712. This parameter may be set to (and may default to) “always”, indicating that the user wants the “send to” action 710 to be carried out every time the subscription filter is matched.

Another use of the “when” parameter is shown, by way of illustration, in the second selection 720. This action can be selected if the user wants time scheduled on his/her electronic calendar when the subscription filter is matched. For example, the user might like to take some time to review details of a new job posting that has been detected using his/her subscription filter. As shown in drop-down list 721, a time period such as 30 minutes might be selected for this “schedule calendar” action 720, and the user might further specify that this automated scheduling is only to happen on week days, as indicated in the “when” drop-down list 722.

A number of different approaches to determining the actions to be presented to a user were described above. In still another approach, embodiments of the present invention may be adapted for providing one or more actions without user input. For example, a default action might be taken when a user's subscription filter matches, without deviating from the inventive concepts disclosed herein. One example of such a default action is to always send the matching content to a user's computer, and a user-to-device mapping might be consulted to determine how to connect to a particular user's computer for content delivery. (Preferred embodiments leverage a commercially-available mechanism for the actual delivery of the content, as discussed in more detail below.)

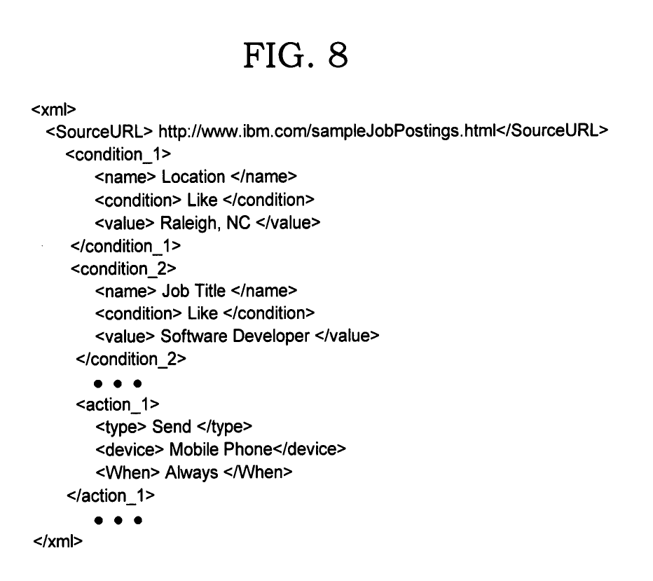

As stated previously with reference to Block 560 of FIG. 5, the customization information is sent by the CP2XML component to a trigger handler component. This passing of information is also depicted at reference number 1504 of FIG. 15, and the trigger handler is shown at reference number 1540. In preferred embodiments, the information passed to the trigger handler by the CP2XML component is encoded as an XML document. A sample document for the job postings scenario, corresponding to the customizations illustrated in FIGS. 4 and 7, is presented in FIG. 8.

The trigger handler 1540 of preferred embodiments transforms the XML document received from the CP2XML component into a trigger that a content matching engine understands. Preferably, a commercially-available content matching engine which operates in a publish/subscribe mode is leveraged, and the transformation performed by the trigger handler component comprises adapting the XML document to the application programming interface (“API”) used by that content matching engine. The content matching engine is depicted in FIG. 15 at reference number 1570, and the passing of the adapted XML document from the trigger handler to the content matching engine is shown at 1505. (The format of the XML document passed to the content matching engine which will vary, depending on the API of the particular content matching engine which is deployed with an implementation of the present invention, and this document has therefore not been illustrated.)

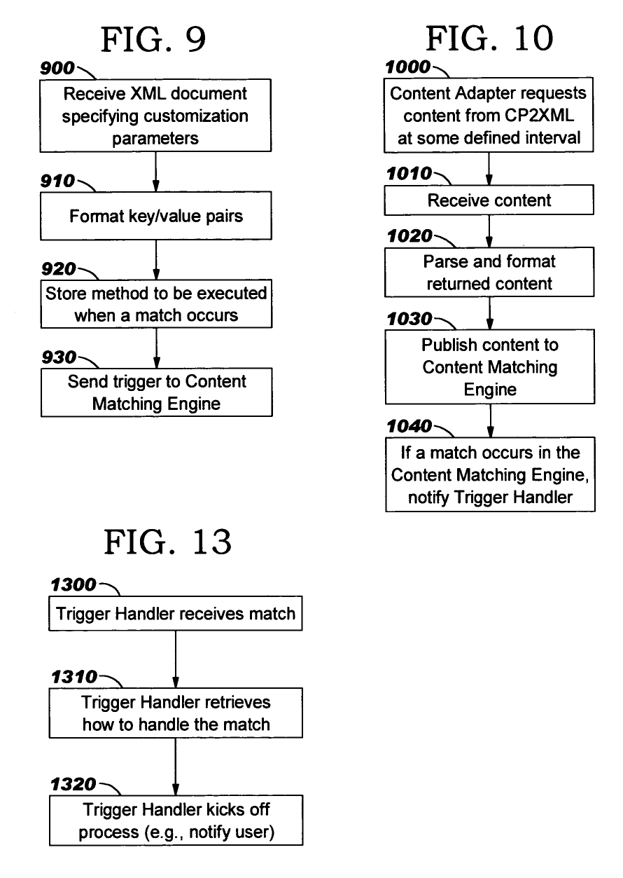

The flowchart in FIG. 9 depicts logic which may be used when implementing this transformation aspect of the trigger handler. As shown therein at Block 900, the trigger handler receives the XML document specifying customization information (e.g., XML document 800 of FIG. 8) from the CP2XML component. The information is then formatted (Block 910), preferably into key-value pairs (or another format, as appropriate to the content matching engine's API), specifying conditions that are to be considered as a match when the content matching engine evaluates content. (This set of formatted conditions may alternatively be referred to as a “trigger”.) Block 920 indicates that the trigger handler stores information about which method(s) should be executed when a particular match occurs. For example, with reference to the sample customization depicted in FIGS. 4 and 7, a method that sends content to a mobile device and (if selected by the user) a method that schedules events on electronic calendars would be recorded by Block 920 when processing this customization. The formatted information is then sent (Block 930) to the content matching engine.

Upon receiving information from the trigger handler, the content matching engine 1570 registers that information (using techniques which are outside the scope of the present invention) for use when subsequently evaluating Web page content.

At this point, a subscription has been dynamically created and registered. A description of how this subscription is used to deliver content to the user (and/or to perform other actions desired by the user) will now be provided, referring to FIGS. 10-15.

Preferred embodiments use a content adapter component, shown at reference number 1560 of FIG. 15, to periodically initiate a content evaluation operation. A timer-driven approach may be used, whereby the content adapter initiates the evaluation at some predetermined or configurable interval(s). Or, an event-driven approach may be used. Discussions hereinafter are in terms of using a timer-driven approach, by way of illustration.

The content adapter of preferred embodiments initiates a content evaluation by querying the CP2XML component, as shown at reference number 1506 of FIG. 15, which in turn causes a second aspect of the CP2XML component to retrieve data from the source Web page, as shown at reference number 1507. The flowchart in FIG. 10 depicts logic that may be used when implementing the content adapter functionality, as will now be described.

When the periodic interval is triggered, the content adapter sends a request to the CP2XML component (Block 1000). The flowchart in FIG. 11 depicts logic that may be used for this second (i.e., content retrieval) aspect of the CP2XML component. As indicated at Block 1100 of FIG. 11, the CP2XML component preferably listens on a socket (referred to in FIG. 11 as “socket Y”, for illustrative purposes) for incoming requests from the content adapter, and in preferred embodiments, each request specifies the URL of the content to be evaluated. (In alternative embodiments, the CP2XML component may use information it saved at Block 510 of FIG. 5, illustrated by association 511, to determine the URL of interest. In this approach, the content adapter preferably passes the subscription identifier, such as “subscription00” or “JobPostingsClipper”, rather than the URL.)

The CP2XML component then requests that the Web clipping engine clip content from a current version of the Web page associated with that URL, and this clipped content is preferably returned to the CP2XML component as a table formatted in HTML (Block 1110). Preferably, the same XPath code used when sending the subscription information to the CP2XML component at reference number 1502 is used for creating this HTML table. Upon receiving the table data (Block 1120) from the Web clipping component, this aspect of the CP2XML component transcodes and re-formats the items, preferably by column header (Block 1130), to create a markup language document (which is preferably encoded in XML). See, for example, reference number 1550 of FIG. 15, which depicts a sample XML document that includes at least one “item” element having “name” sub-elements for each column header and “value” sub-elements for each of those columns.

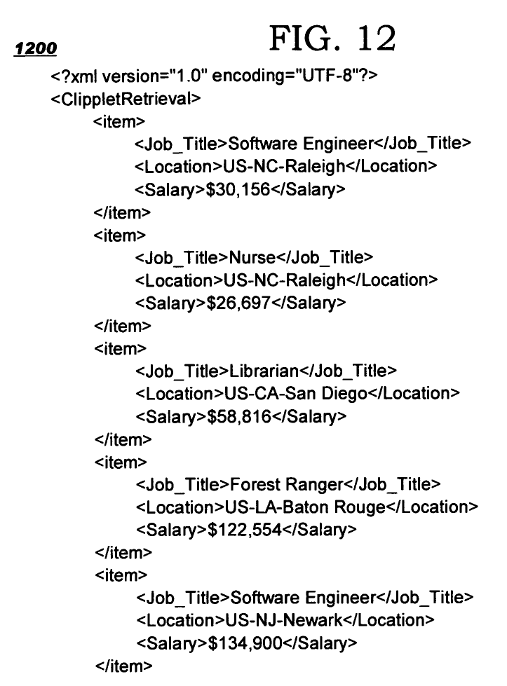

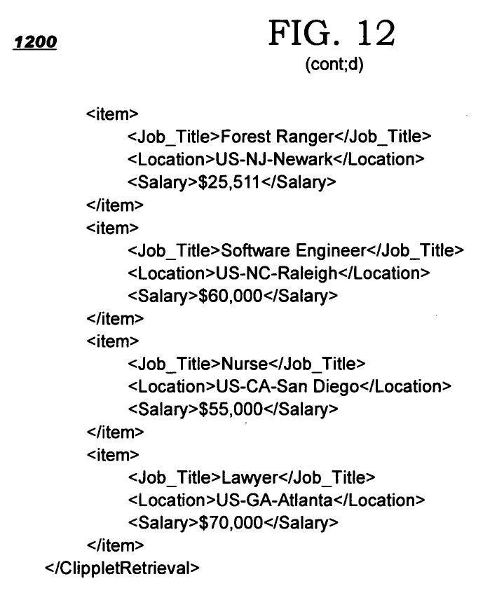

A sample XML document 1200, created at Block 1130 after the CP2XML engine has received results of a fresh query to the Web page illustrated in FIG. 1, is depicted in FIG. 12. As shown therein, a number of new job postings have been created, and several of the previously-posted jobs (referring to the previous Web page content shown in FIG. 1) have now been removed. This new XML document is then returned to the content adapter (Block 1140). This passing of the revised content in an XML document is illustrated in FIG. 15 at reference numbers 1508a, 1508b.

Returning now to the discussion of content adapter functionality in FIG. 10, when the content adapter receives content from the CP2XML component (Block 1010), it parses and formats that returned content (Block 1020) for delivery to the content matching engine. Preferably, this comprises formatting the returned XML document (as illustrated by example document 1200 in FIG. 12) into a form suitable for the content matching engine. This content is then published (i.e., submitted) to the content matching engine (Block 1030), as shown at reference number 1509 of FIG. 15, where it will be evaluated using triggers sent from the trigger handler component (as described above with reference to 1505 of FIG. 15). This comparison of content to triggers (i.e., conditions) preferably uses prior art techniques which are outside the scope of the present invention, as stated earlier.

If a match is detected by the content matching engine, then Block 1040 notifies a second aspect of the trigger handler. The notification preferably comprises sending a message to this aspect of the trigger handler, indicating which trigger has matched. The notification is also shown by reference number 1510 of FIG. 15, and FIG. 13 provides a flowchart depicting logic with which the second aspect of the trigger handler may be implemented. As shown therein, when this aspect of the trigger handler is notified of a match (Block 1300), it retrieves previously-stored information (Block 1310) about how to handle this match. For example, one or more method names are preferably stored for each potential match, as has been described above with reference to Block 920 of FIG. 9. Upon locating this stored information, Block 1320 kicks off the associated process or method. For example, with reference to the customization shown in FIGS. 4 and 7, the content received by the content adapter at Block 1010 is delivered to the user's mobile phone if it matches the Location, Job Title, and Salary parameters specified by this user (according to the user's selection at reference number 711 of FIG. 7). In the general case, one or more actions may be taken by the trigger handler at Block 1320, depending on the actions defined in the subscription for which the trigger matches the updated content published at 1509.

Preferably, the trigger handler requests an intelligent delivery engine 1580 to carry out delivery to devices, when delivery of content is indicated as an action. This request is shown at reference number 1511 in FIG. 15, and the intelligent delivery engine is preferably a commercially-available component whose functionality is beyond the scope of the present invention. As shown in the sample configuration in FIG. 15, the intelligent delivery engine may be adapted for routing messages 1512 to devices including mobile phones 1513, pagers 1514, and/or portable computing devices 1515. The intelligent delivery engine functionality may be provided, for example, by the Intelligent Notification Service, or “INS”, product of IBM. (Note that, in contrast to the present invention, users of the existing INS product can subscribe only to content having a deployed subscription interface for content updates. The subscription interface is sometimes referred to in the prior art as a “notification service”, “notification application”, or “subscriber delivery channel”.)

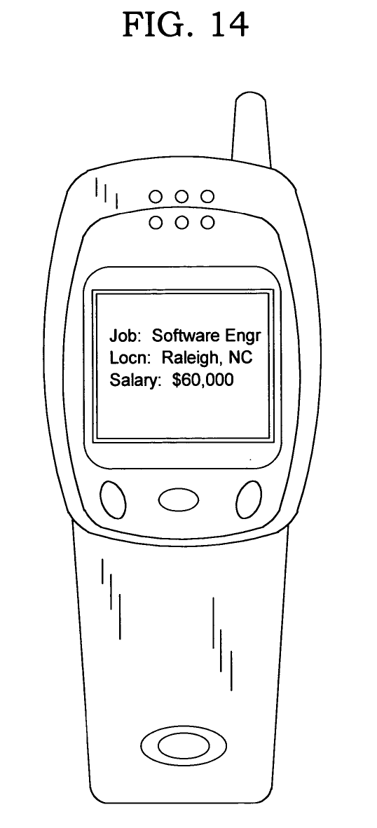

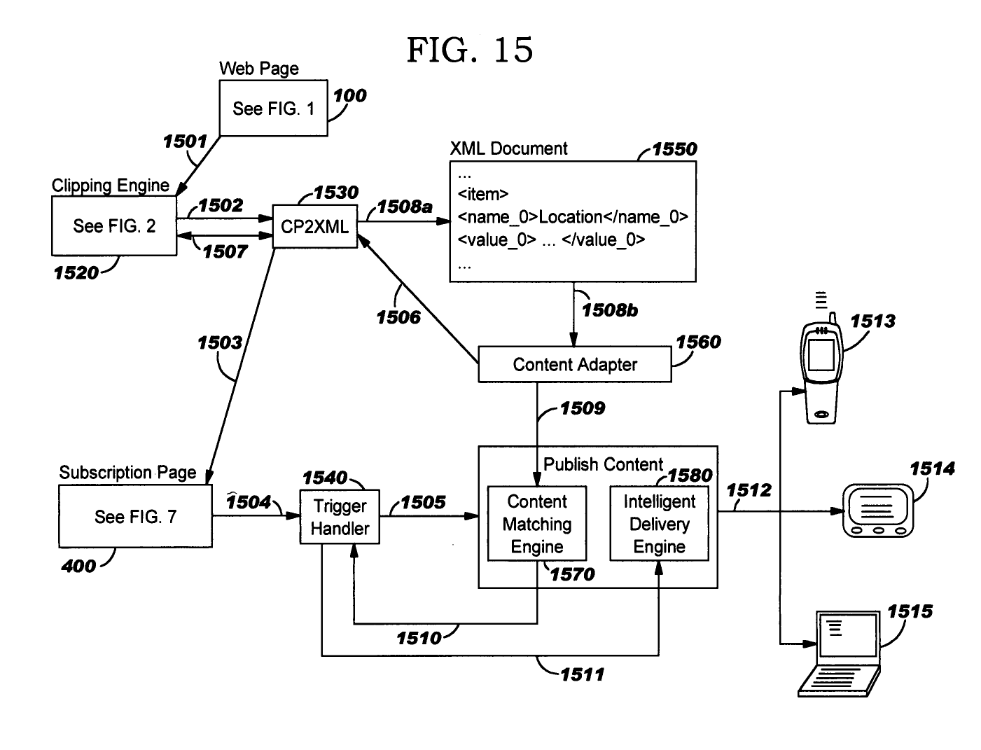

FIG. 14 illustrates delivery of a sample message, via the intelligent delivery engine, to a user's mobile phone. As shown therein, this message notifies the user that a job is available meeting certain criteria for location, job title, and salary, in accordance with the user's dynamically-created subscription filter. Note that the sample message displayed in FIG. 14 illustrates an optional enhancement that may be used with preferred embodiments, whereby information is translated or transcoded for delivery to particular devices. For example, “Job Title” has been shortened to “Job” and “Software Engineer” has been shortened to “Software Engr”, in view of the message destination being a mobile device with constraints upon display size. In addition, this example shows that the ordering of Job Title and Location information has been switched; “Location” has been shortened to “Locn”; and the actual location value from the updated content (“US-NC-Raleigh”, in this example) has been replaced with a more user-friendly version.

Returning now to the content adapter and trigger handler, these components are preferably deployed as paired, customized components. For example, one content adapter may be customized for processing information about job postings (e.g., receiving this information and delivering it to the content matching engine), while another content adapter may be customized for processing information about stock prices. A trigger is defined by type (e.g., stock, weather, news, etc.) and when the content matching engine determines a match, it passes the type to the trigger handler. The trigger handler then knows how to handle the match, according to the type.

As has been described, embodiments of the present invention provide a number of advantages to end users and to companies. An implementation of the present invention may be offered as a stand-alone product or as a service, or it may be coupled or integrated with another software product such as IBM's WebSphere® Everyplace® Access or IBM's INS product. (“WebSphere” and “Everyplace” are registered trademarks of International Business Machines Corporation.)

As will be appreciated by one of skill in the art, embodiments of the present invention may be provided as methods, systems, or computer program products. Accordingly, the present invention may take the form of an entirely hardware embodiment, an entirely software embodiment, or an embodiment combining software and hardware aspects. Furthermore, the present invention may take the form of a computer program product which is embodied on one or more computer-usable storage media (including, but not limited to, disk storage, CD-ROM, optical storage, and so forth) having computer-usable program code embodied therein. In addition, the present invention may be offered as a method of doing business (for example, whereby user subscriptions are processed and used for delivering content, and so forth).

The present invention has been described with reference to flow diagrams and/or block diagrams of methods, apparatus (systems), and computer program products according to embodiments of the invention. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a general purpose computer, special purpose computer, embedded processor, or other programmable data processing apparatus to produce a machine, such that the instructions, which execute via the processor of the computer or other programmable data processing apparatus, create means for implementing the functions specified in the flow diagram flow or flows and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flow diagram flow or flows and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flow diagram flow or flows and/or block diagram block or blocks.

While preferred embodiments of the present invention have been described, additional variations and modifications in those embodiments may occur to those skilled in the art once they learn of the basic inventive concepts. Therefore, it is intended that the appended claims shall be construed to include preferred embodiments and all such variations and modifications as fall within the spirit and scope of the invention.

1. A method of selectively subscribing to content in a computing environment, comprising steps of:
enabling a user to identify content of interest, wherein a provider of the content has not provided a subscription interface thereto; and
registering a subscription, for the user, to the identified content.

2. The method according to claim 1, further comprising the step of:
using the registered subscription to deliver updates of the identified content to the user.

3. The method according to claim 1, further comprising the step of:
enabling the user to customize the identification such that at least one condition is placed on at least one portion of the identified content, wherein the at least one portion may comprise the identified content in its entirety and wherein the content provider may have provided the subscription interface to the identified content but has not provided a subscription interface using all of the conditions and/or all of the portions; and
wherein the registering step further comprises registering the customization.

4. The method according to claim 3, further comprising the step of:
using the registered subscription to deliver updates of the identified content which match the conditions to the user.

5. The method according to claim 3, further comprising the steps of:
specifying, for the user, at least one action to be carried out when the conditions are matched in updates of the identified content.

6. The method according to claim 5, further comprising the step of:
evaluating the registered subscription, and if the condition(s) therein are met in updates to the identified content, carrying out the action(s).

7. A system for selectively subscribing to content in a networking environment, further comprising:
means for receiving an identification of content of interest to a user, wherein a provider of the content has not provided a subscription interface thereto; and
means for registering a subscription, for the user, to updates of the identified content.

8. The system according to claim 7, further comprising:
means for using the subscription to deliver updates of the identified content to the user.

9. The system according to claim 7, wherein the means for receiving and means for registering are adapted for receiving identifications of content of interest to a plurality of users and registering subscriptions to updates of the identified content for the plurality of users, respectively.

10. A computer program product for selectively subscribing to content in a networking environment, the computer program product embodied on one or more computer-readable media and comprising:
computer-readable program code means for receiving an identification of content of interest to a user, wherein a provider of the content has not provided a subscription interface thereto; and
computer-readable program code means for registering a subscription, for the user, to updates of the identified content.

11. The computer program product according to claim 10, further comprising:
computer-readable program code means for using the subscription to deliver updates of the identified content to the user.

12. The computer program product according to claim 10, wherein the computer-readable program code means for receiving and computer-readable program code means for registering are adapted for receiving identifications of content of interest to a plurality of users and registering subscriptions to updates of the identified content of the plurality of users, respectively.
